(19) United States
(12) Patent Application Publication
(10) Pub. No.: US 2015/0269664 A1
(43) Pub. Date: Sep. 24, 2015

(54) SOLAR PANEL WATTAGE DETERMINATION SYSTEM

(71) Applicant: Opower, Inc., Arlington, VA (US)

(72) Inventor: John Morgan McLellan Davidson, Berkeley, CA (US)

(21) Appl. No.: 14/466,788

(22) Filed: Aug. 22, 2014

Related U.S. Application Data
(60) Provisional application No. 61/955,591, filed on Mar. 19, 2014.

(51) Int. Cl. G06Q 40/00; G06Q 50/06

(52) U.S. Cl. CPC G06Q 40/00; G06Q 50/06

(57) ABSTRACT

Techniques for solar panel wattage determination are provided. A computing device can determine a potential wattage output of a candidate solar panel array using insolation data for a corresponding geographic region, and determine potential energy consumption for a property of a utility customer in the corresponding geographic region using usage data from the property. The computing device can adjust a size of the candidate solar panel array to vary the potential wattage output, and apply a different rate plan to the potential energy consumption for each adjustment to the potential wattage output. The computing device can determine that one of the wattage output adjustments yields a cost efficiency metric that is less than a predetermined threshold. In turn, the computing device provides a notification of the candidate solar panel array corresponding to the cost efficiency metric being less than the predetermined threshold as a recommendation to the corresponding utility customer.

### CROSS-REFERENCE TO RELATED APPLICATIONS

The present application claims the benefit of priority to U.S. Provisional Application Ser. No. 61/955,591, filed Mar. 19, 2014, titled “USER-FRIENDLY AND ACCURATE WAY OF DETERMINING IDEAL SOLAR PANEL WATTAGE,” of which is hereby incorporated by reference in its entirety.

### BACKGROUND

The subject technology relates to data processing systems, and in particular, to a solar panel wattage determination system.

Utility customers who are interested in installing solar panels need to make a judgment on how much wattage should be installed. In existing approaches, solar panel installers utilize imprecise algorithms to generate solar panel sizing estimates, which cause utility customers not to realize the return-of-investment as expected. For example, calculators that determine such wattage typically prompt customers to enter billing and/or usage information for each calendar month in a previous year. While these approaches provide a macro view of how utility customers use energy, the wattage determinations that result from these calculators typically overestimate the sizing of solar panel systems.

### SUMMARY

According to various aspects of the subject technology, a solar panel wattage determination system is described.

In an aspect, a computing device for solar panel wattage determination includes at least one processor and memory storing instructions that, when executed by the at least one processor, cause the computing device to perform various operations. The computing device can obtain insolation data for a corresponding geographic location, in which the insolation data relates to a total amount of solar radiation energy received on a surface area of a candidate solar panel array during a specified time period in the corresponding geographic location. The computing device can determine a potential wattage output from the candidate solar panel array based on the insolation data and a rating of the candidate solar panel array, in which the potential wattage output corresponds to a size of the candidate solar panel array. The computing device can determine usage data relating to a gross amount of energy consumed by at least one of a property or a component of the property, in which the property is associated with a corresponding utility customer in the corresponding geographic location. The computing device can determine net energy consumption based at least in part on a difference between the usage data and the potential wattage output. The computing device can determine that the potential wattage output of the candidate solar panel array provides a cost efficiency metric that is less than a predetermined threshold, in which the cost efficiency metric relates to a projected financial benefit to the corresponding utility customer. The computing device can generate a message including an indication of the candidate solar panel array with the adjustment corresponding to the cost efficiency metric that is less than the predetermined threshold. The computing device can further provide the message as a recommendation to the corresponding utility customer.

In another aspect, a computer-implemented method including steps for solar wattage determination is provided. The method includes the step of determining a potential energy contribution from a candidate solar panel array based at least in part on insolation data for a corresponding geographic region. The method includes the step of determining a potential energy consumption relating to energy consumed by a property of a corresponding utility customer, in which the property is located within the corresponding geographic region. The method includes the step of combining the potential energy contribution with the potential energy consumption to determine net energy consumption. The method includes the step of determining a cost efficiency metric relating to a projected financial benefit to the corresponding utility customer based at least in part on one or more adjustments to the net energy consumption. The method further includes the step of providing a notification including an indication of the solar panel array with the adjustment corresponding to the cost efficiency metric as a recommendation to the corresponding utility customer.

In still another aspect, a non-transitory computer readable storage medium storing instructions for solar panel wattage determination on a computing device, the instructions when executed by a processor, causing the computing device to perform various operations. The computing device can determine a potential wattage output of a candidate solar panel array using insolation data for a corresponding geographic region. The computing device can determine potential energy consumption for a property of a corresponding utility customer based at least in part on usage data of the property, in which the property is located within the corresponding geographic region. The computing device can adjust a size of the candidate solar panel array to vary the potential wattage output. The computing device can apply a different rate plan to the potential energy consumption for each change in the potential wattage output. The computing device can determine that one of the changes in the potential wattage output of the candidate solar panel array provides a cost efficiency metric that is less than a predetermined threshold. The computing device can further provide a notification including an indication of the candidate solar panel array corresponding to the cost efficiency metric that is less than the predetermined threshold as a recommendation to the corresponding utility customer.

### BRIEF DESCRIPTION OF THE DRAWINGS

In the following description, reference is made to the following figures, and in which are shown by way of illustration specific embodiments in which the subject technology may be practiced. It is to be understood that other embodiments may be utilized and changes may be made without departing from the scope of the subject technology.

FIG. 1 illustrates an example of a solar panel wattage determination system, according to certain aspects of the subject technology.

FIGS. 2A-2F illustrate examples of a process for the solar panel wattage determination system, according to certain aspects of the subject technology.

FIG. 3 illustrates a flowchart of an example process for the solar panel wattage determination system described in FIGS. 2A-2F, according to certain aspects of the subject technology.

FIG. 4 illustrates an example of an energy usage notification including a solar panel wattage determination, according to certain aspects of the subject technology.

FIG. 5 illustrates an example of an environment for implementing aspects in accordance with various embodiments.

FIG. 6 illustrates an example of a solar panel wattage determination system, according to certain aspects of the subject technology.

FIG. 7 illustrates an example configuration of components of a computing device, according to certain aspects of the subject technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Utility-provided grid utilization information may be examined to identify a portion of a utility grid that needs additional capacity (e.g., a portion of the grid that is strained). The grid may comprise an electrical grid that delivers electricity generated by one or more power sources (e.g., power plant) to users (e.g., utility customers) distributed over a geographical area. In this example, a user with a solar panel installation may be able to connect the solar panels to the grid to supply excess electrical power from the solar panels (electrical power that the user does not consume) to the grid for use by other users on the grid. Thus, additional capacity may be provided to a portion of the grid that is strained by installing solar panels at user sites (e.g., residential homes) located within and/or near that portion of the grid. This may be a more cost-effective solution for a utility to reduce strain on the grid compared with building an additional power plant. Further, by consuming power generated by the solar panels instead of power from the grid, the user further reduces strain on the grid.

As discussed above, the existing approaches for calculating the wattage needed for a potential solar panel system does not take into account how a utility customer uses energy during the course of the day or the rate that is applied to their energy consumption. For example, utility customers use energy at different times of the day and can pay different rates for that usage. The subject technology allows for utility customers, utility providers and/or solar panel providers to understand how the utility customer's usage changes over the course of the day, the price they are paying for that usage, and the energy that is generated by a potential solar panel system in order to provide a more accurate estimation. In some aspects, utilizing advanced meter infrastructure (AMI) data can result in providing more accurate estimates, and determining how the utility customer's rate applies prices to their usage can result in incremental improvement.

In some aspects, the computing device can determine a potential wattage output of a candidate solar panel array using insolation data for a corresponding geographic region. The computing device can determine potential energy consumption for a property of a corresponding utility customer based at least in part on usage data of the property, in which the property is located within the corresponding geographic region. The computing device can adjust a size of the candidate solar panel array to vary the potential wattage output. The computing device can apply a different rate plan to the potential energy consumption for each change in the potential wattage output. The computing device can determine that one of the changes in the potential wattage output of the candidate solar panel array provides a cost efficiency metric that is less than a predetermined threshold. For example, the cost efficiency metric describes the user's return-of-investment in terms of the total upfront cost to install a solar panel system per watt of generation capacity. In this regard, having the solar panel system generate sufficient energy to support the user's usage rate and compensate for the installed cost can help the user realize the return-of-investment sooner than projected. In turn, the computing device can provide a notification including an indication of the candidate solar panel array corresponding to the cost efficiency metric that is less than the predetermined threshold as a recommendation to the corresponding utility customer.

As used herein, the term “insolation” refers to the total amount of solar radiation energy received on a given surface area during a given time. The term “usage” described herein refers to a quantity of use, a cost associated with the use, or a quantified metric representing the use or cost. The term “gross amount of energy” described herein refers to a utility meter reading or a usage reading. The term “commodity” described herein refers to a utility-based commodity, such as electricity, water, and natural gas, which are consumable finite resources delivered to a dwelling or a commercial structure. The term “component of a property” described herein refers to a component associated with the property that is able to consume a commodity. One example of a component of a property may be a heating, ventilation and air conditioning (HVAC) system that controls the climate within the property using electricity, natural gas, and/or another commodity. The component may relate to one or more of a central heating device, a central air conditioning and heating system, an appliance, an electronic device, water heating system, a power generating device, a ventilation system, or an air filtration system. The term “projected financial benefit” refers to one or more an amount of cost projected to be reduced from a utility energy bill or an amount of income projected to be generated based on an amount of energy generated from an energy source (e.g., solar panel system).

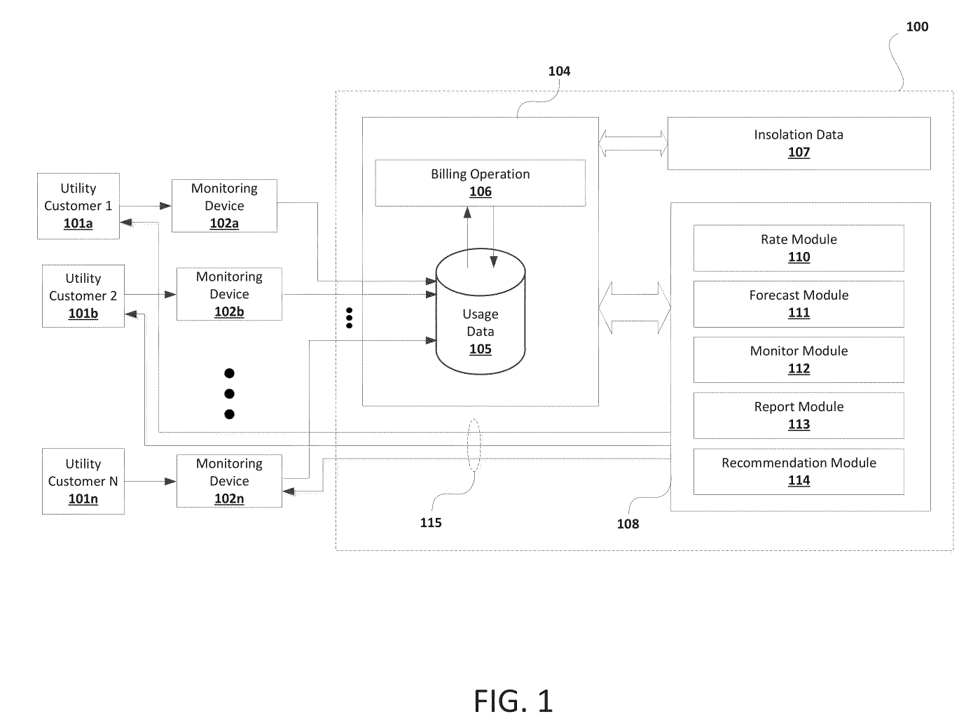

FIG. 1 illustrates an example of a utility management system 100, according to certain aspects of the subject technology. The utility management system 100 includes a billing management system 104 and a solar panel wattage determination system 108. The billing management system 104 is coupled to utility customers 101 via monitoring devices 102. The billing management system 104 includes usage database 105 and a billing operation module 106. The billing management system 104 is communicatively coupled to solar insolation data 107. The solar panel wattage determination system 108 includes a rate module 110, a forecast module 111, a monitor module 112, a report module 113 and a recommendation module 114. The solar panel wattage determination system 108 may convey information targeted to one or more of the utility customers 101a-101n over communication channels 115.

The billing management system 104 stores usage data in the usage database 105. The usage data is associated with one or more commodities consumed by the utility customers 101. The usage data may include usage information corresponding to usage of at least one of the one or more commodities for multiple utility customers (e.g., utility customers 101a, 101b . . . 101n). The usage-information may include past usage information of the commodity during a completed billing period or current usage information of the commodity during a completed portion of a current billing period. The usage data for a utility customer may be obtained from a corresponding monitoring device on a scheduled basis, periodic basis or a non-scheduled basis. The monitoring devices (e.g., monitoring devices 102a, 102b . . . 102n) may relate to an advanced metering infrastructure (AMI). In this respect, the monitoring devices may be smart meters or, at least in part, include smart meter functionality for measuring electrical, water and/or natural gas consumption in the property associated with the corresponding utility customer. For example, the usage data may consist of usage information corresponding to the property in its entirety such that usage information relating to one or more components in the property is disaggregated by the billing management system 104 and/or the solar panel wattage determination system 108. In one embodiment, the monitoring devices relate to conventional utility meters (e.g., non-AMI data). For example, AMI smart meters may record energy usage (or consumption) at multiple intervals in a billing period, report such energy usage over a data communication network at each interval in the billing period, and provide an interface to configure remote reporting. In contrast, non-AMI meters may record energy usage based on meter readings obtained at an end of the billing period without the capability to monitor changes in energy usage throughout the billing period. In an aspect, the billing management system 104 stores and forwards the usage data to the solar panel wattage determination system 108 for solar panel design processing. The billing management system 104 may forward the usage data to the solar panel wattage determination system 108 for storage and solar panel wattage determination processing. The utility management system 100 described herein may refer to a utility company, an offsite third party service provider that is interfaced with the utility company, or a combination of different entities.

The solar insolation data 107 includes data referring to the total amount of solar radiation energy received on a given surface area during a given time. Solar insolation also may be referred to as solar irradiation and expressed as “hourly irradiation” if recorded during an hour or “daily irradiation” if recorded during a day. Insolation figures can be used as an input to size solar power systems for the location where they will be installed. In some aspects, the solar insolation data 107 may be retrieved from a database associated with the utility management system 100 or received from a third-party provider of insolation data.

The rate module 110 may store a local copy of a rate plan (or schedule) associated with the fees for commodities provided by the utility company. The rate module 110 may be configured to obtain the rate plan, associated with the current billing period and a particular customer, from the utility company. The utility company may implement time-of-use rates, in which electricity rates vary depending on the time of day and/or environmental factors (e.g., forecasted weather). In some aspects, the rate plan may also include a schedule of various rates that specify how much the utility company will pay for electricity provided by utility customers (e.g., via solar panels). For example, electricity rates may be higher during peak hours (e.g., daylight hours) when demand is higher compared with electricity rates during non-peak hours (e.g., nighttime hours). The utility company may do this in an effort to reduce energy consumption and/or promote energy production during peak hours when strain on the grid may be greatest. In some cases, a utility customer that consumes a large amount of energy during peak hours (e.g., heavy daytime user) may reduce his/her utility bill by a greater amount by installing solar panels compared with a utility customer that consumes less energy during peak hours. Thus, a utility customer that consumes a large amount of energy during peak hours may have a greater financial incentive to install solar panels. Similarly, a utility customer that consumes energy corresponding to higher-priced tiers, when rate tiers are implemented by the utility company, may be incentivized to pursue solar panel installation.

The forecast module 111 may be configured to forecast the projected use of energy by the utility customers 101a-101n based on the corresponding usage data. The forecast module 111 may include an algorithm used to determine the projected use information using the rate-of-use information and billing period information.

The monitor module 112 may include an interface to the monitoring devices 102a-102n to obtain the usage data directly and/or include an interface with the billing management system 104 to receive the usage data for further processing by one or more components of the solar panel wattage determination system 108 (e.g., rate module 110, recommendation module 114). Usage information for a utility customer across a day may be obtained from a smart meter (e.g., at the user's residence). The smart meter may monitor the energy consumption of the utility customer, and report the energy consumption of the utility customer in relatively small time intervals (e.g., of an hour or less) to a utility database (e.g., via a network connection). This information can be used to determine how much energy the utility customer consumes during different times of the day, and therefore whether the utility customer consumes a large amount of energy during peak hours. For example, the usage information may be used to determine an amount of energy (e.g., kWh) the utility customer consumes during peak hours (e.g., 10 a.m. to 6 p.m. or other time period).

The report module 113 may be configured to generate an energy usage notification, and cause the energy usage notification to be sent to one or more of the utility customers 101a-101n based on one or more reporting conditions (e.g., cost efficiency metric less than a predetermined threshold, current billing period ended, utility customer inquiry, etc.) through the communication channels 115. The energy usage notification may include an indication to the utility customer that alterations can be pursued to reduce future energy costs. For example, the indication may include a recommendation to the utility customer that one or more alternative energy strategies (e.g., solar power generation) are available to the utility customer based on one or more aspects about the utility customer's energy usage pattern.

The recommendation module 114 may be configured to generate one or more recommendation messages for inclusion into an energy usage notification and/or a separate notification to the utility customers 101a-101n. For example, the recommendation messages may relate to a recommendation to install a solar panel system to incentivize a targeted utility customer to improve energy conservation at the home. The one or more recommendation messages may include information for obtaining a cost estimate from a third party service provider to install the candidate solar panel array at the property.

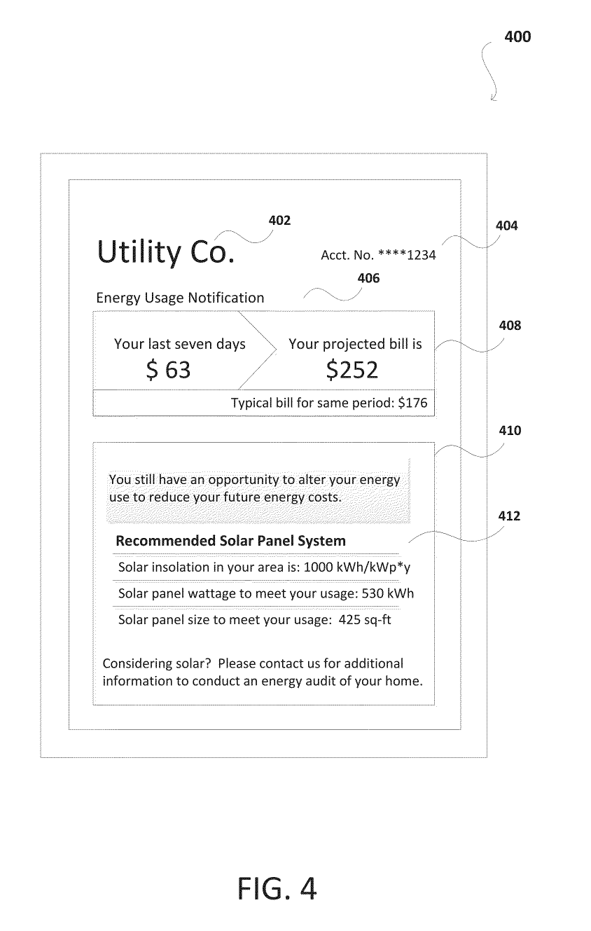

The communication channels 115 may carry different types of notifications to the utility customers 101a-101n over a wired and/or a wireless communication. In an aspect, the solar panel wattage determination system 108 sends the notification in a broadcast and/or multicast signal to the utility customers 101a-101n. The solar panel wattage determination system 108 may specifically target one or more of the utility customers 101a-101n, and send a personalized notification (e.g., energy usage notification 400 of FIG. 4) over a unicast signal. The communication channels 115 may be configured to interface to a smart meter (e.g., the monitoring devices 102a-102n), a climate control device (e.g., a network-connected thermostat), a customer's mobile device, a data exchange interface of a cellular network, and other networks.

In operation, the solar panel wattage determination system 108 can determine a potential wattage output of a candidate solar panel array using the insolation data 107 for a corresponding geographic region. The solar panel wattage determination system 108 can determine potential energy consumption for a property of a corresponding utility customer (e.g., utility customers 101a-101n) based at least in part on usage data of the property, in which the property is located within the corresponding geographic region. The solar panel wattage determination system 108 can adjust a size of the candidate solar panel array to vary the potential wattage output. The computing device can apply a different rate plan to the potential energy consumption for each change in the potential wattage output.

The solar panel wattage determination system 108 can determine that one of the changes in the potential wattage output of the candidate solar panel array provides a cost efficiency metric that is less than a predetermined threshold. The predetermined threshold may relate to a break-even point for the user such that any additional energy generation beyond the break-even point (e.g., the cost efficiency metric being less than the predetermined threshold) yields a projected financial benefit (e.g., reduced energy bill, income) to the user. In this regard, the cost efficiency metric describes the user's return-of-investment in terms of the total upfront cost to install a solar panel system per watt of generation capacity. In this regard, the greater the watt of generation capacity versus the installed cost, the sooner the user can realize the return-of-investment since the cost savings is realized at a higher rate when the solar panel system is set to an optimal size.

In turn, the solar panel wattage determination system 108 can provide a notification including an indication of the candidate solar panel array corresponding to the cost efficiency metric that is less than the predetermined threshold as a recommendation to the corresponding utility customer.

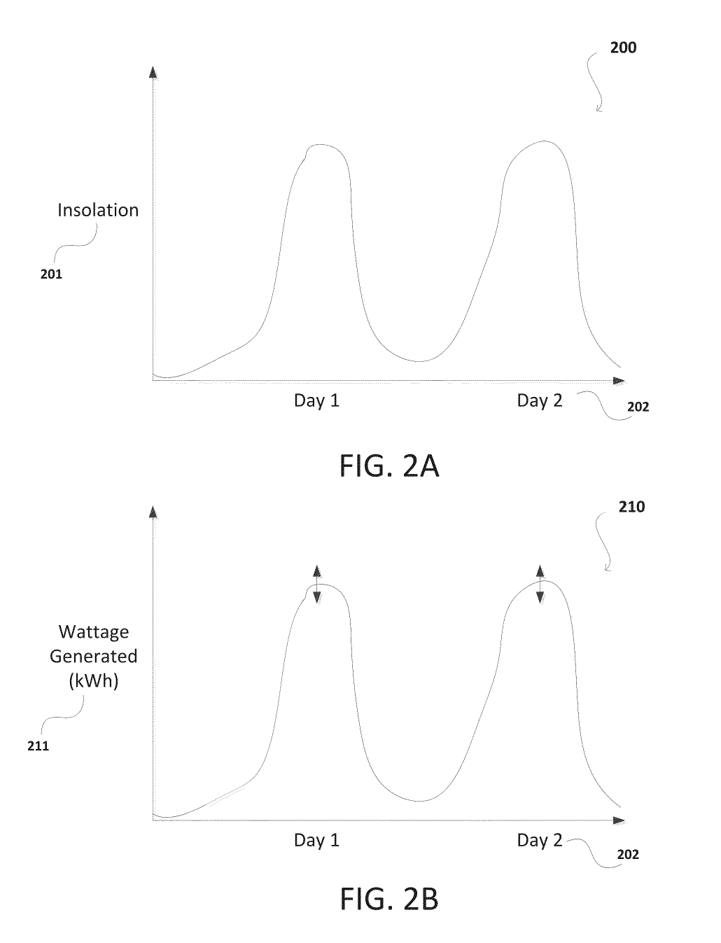

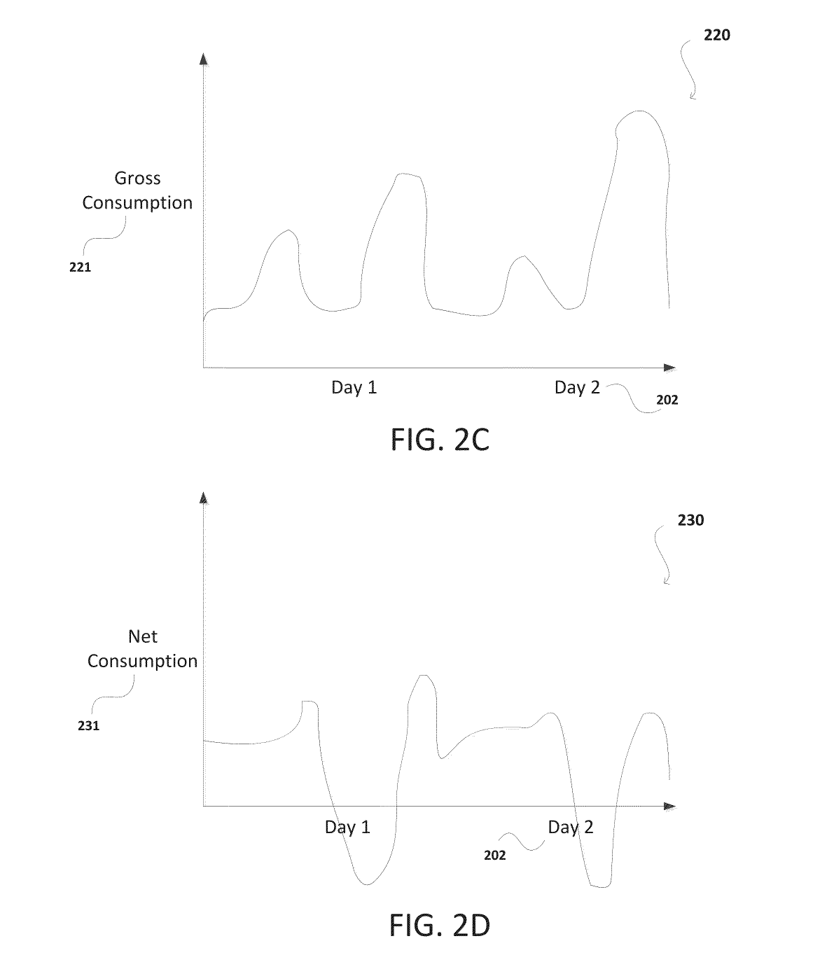

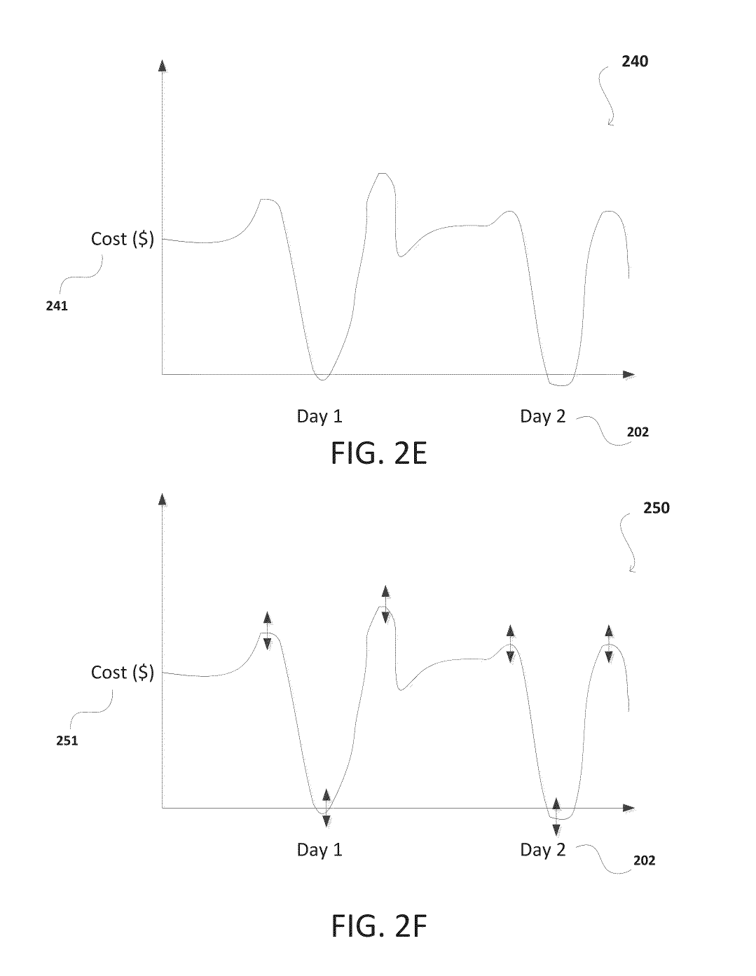

FIG. 2A illustrates a plot 200 relating to an example of solar insolation determination, according to certain aspects of the subject technology. The plot 200 includes a two-dimensional representation of the variation in the insolation 201 (e.g., y-axis) obtained over time 202 (e.g., x-axis). In FIG. 2A, the amount of insolation (e.g., amount of radiation received per unit area) increases towards the middle of the day (e.g., when sunlight is strongest) in Day 1 and decreases towards the end of Day 1 (e.g., approaching nightfall). Similarly, the amount of insolation follows a similar pattern for Day 2.

The location of the home (e.g., the property associated with a corresponding utility customer) may also affect the solar insolation received at the home. The isolation for the home may be determined based on the location of the home, and a radiation map indicating insolation for different regions on the Earth. For example, the insolation may be higher for a home located in the Southwestern United States than a home located in the Northeastern United States. Insolation values can range from 800 kWh/(kWp·y) up to 2,900 depending on the region. In an aspect, the insolation figures are obtained from an insolation map or by city or region from insolation tables that were generated with historical data (e.g., over the last 30 to 50 years). According to other aspects of the subject technology, the solar insolation of a home may further be affected by even more local factors such as the amount of shade (e.g., from trees or other buildings) that falls on portions of the home. This type of insolation data may be determined based on satellite images or other sources. Once the insolation is determined, the insolation data may be stored in a database (or a data structure) for later retrieval and processing.

FIG. 2B illustrates a plot 210 relating to an example of potential wattage output determination, according to certain aspects of the subject technology. The plot 210 includes a two-dimensional representation of the variation in the wattage 211 (e.g., y-axis) generated over time 202 (e.g., x-axis). A computing device can determine the amount of energy (e.g., kWh/day) that could potentially be generated from solar panels of a candidate solar panel array using insolation data for a corresponding geographic region.

The rating of the candidate solar panel array can be used with the insolation data to determine the potential wattage output. Photovoltaic panels are rated under standard conditions to determine the Wp rating (Watts peak), which can then be used with the insolation of a geographic region to determine the expected output, along with other factors such as tilt, tracking and shading (which can be included to create the installed Wp rating).

The roof direction, roof angle, roof area, shading and/or location of the home also may be used to calculate the potential wattage output at the home. The roof direction, roof angle and/or roof area of the home may be determined from a roof plan for the home (e.g., from a publically available database). In another example, the roof direction, roof angle and/or roof area of the home may be estimated by analyzing a satellite image, an aerial image and/or a street-view image of the home (e.g., from a publically available database) using known image processing techniques (e.g., edge detection, classification, etc.). It is to be appreciated that both techniques may be used to determine the roof direction, roof angle and/or roof area of the home.

The location of the home may be used in computing the potential energy of a solar installation for the home because the optimal roof direction (orientation) and/or optimal roof angle for collecting radiation at the home may depend on the location of the home. For example, for a home located in the northern hemisphere (United States market), a roof facing due south may be more optimal than a roof facing due north. By contrast, for a home located in the southern hemisphere, a roof facing due north may be more optimal than a roof facing due south. In another example, for a home located at higher latitude on the Earth, a larger (steeper) roof angle may be more optimal since the sun tends to be lower in the sky at higher latitudes. In this embodiment, the location of the home may be determined, for example, from an address of the home, coordinates of the home, etc.

FIG. 2C illustrates a plot 220 relating to an example of gross energy consumption determination, according to certain aspects of the subject technology. The plot 220 includes a two-dimensional representation of the variation in the gross energy consumption 221 (e.g., y-axis) determined over time 202 (e.g., x-axis). The computing device can determine potential energy consumption for a property of a corresponding utility customer based at least in part on usage data of the property, in which the property is located within the corresponding geographic region. As described above, the usage data may be determined using one or more of a conventional utility meter or a smart meter.

FIG. 2D illustrates a plot 230 relating to an example of net energy consumption determination, according to certain aspects of the subject technology. The plot 230 includes a two-dimensional representation of the variation in the net energy consumption 231 (e.g., y-axis) determined over time 202 (e.g., x-axis). The computing device can combine the potential energy contribution (e.g., the potential wattage output) with the potential energy consumption (e.g., the gross energy consumption) to determine the net energy consumption. In this respect, the amount of energy contributed by the candidate solar panel array reduces the amount of energy consumed off the grid. In FIG. 2D, the net energy consumption dips below 0 to indicate that any energy generated during the corresponding time of the day can be fed back to the grid. In this regard, the energy fed back to the grid can equate to income for the user as will be described in FIG. 2E.

FIG. 2E illustrates a plot 240 relating to an example of energy consumption cost determination, according to certain aspects of the subject technology. The plot 240 includes a two-dimensional representation of the variation in the energy consumption cost 241 (e.g., y-axis) determined over time 202 (e.g., x-axis). In this respect, the computing device can apply a particular rate plan to convert the net energy consumption (in kWh) into a monetary value. In FIG. 2E, the portion of the net energy consumption dipping below the “0” value of y-axis can be considered as energy contribution beyond the user's energy usage such that such energy contribution can convert into an income opportunity for the user (e.g., energy fed back to the grid). In this regard, the computing device can factor the income opportunity into the cost efficiency metric.

FIG. 2F illustrates a plot 250 relating to an example of solar panel array optimization, according to certain aspects of the subject technology. The plot 250 includes a two-dimensional representation of the variation in the cost optimization 251 (e.g., y-axis) determined over time 202 (e.g., x-axis). The computing device can adjust a size of the candidate solar panel array to vary the potential wattage output. The computing device can apply a different rate plan to the net energy consumption for each change in the potential wattage output. The computing device can determine that one of the changes in the potential wattage output of the candidate solar panel array provides a cost efficiency metric that is less than a predetermined threshold.

In an aspect, the cost efficiency metric relates to a ratio of an installed cost of the solar panel array per watt of generation capacity of the solar panel array. Based on the applied rate plan discussed above, the watt of generation capacity may translate to an amount of money saved off an energy bill or an amount of income generated by selling the generated energy back to a utility provider (or grid). In one embodiment, the watt of generation capacity may relate to an amount of wattage produced over a specified length of time (e.g., a specific number of years, over the life of the solar panel installation, etc). In some aspects, the cost efficiency metric corresponds to a default payback period of when the user can realize a return in investment for installing the solar panel system. The cost efficiency metric may be adjustable such that the user can select a different period to allow the user to realize a return in the investment in 10 years as opposed to 15 years, for example.

If the predetermined threshold is set 1.0 (e.g., the installed cost is equal to the monetary value associated with the wattage generation capacity), then an adjustment to the size of the candidate solar panel array yielding a ratio below 1.0 can indicate that the adjustment corresponds to an optimal size for the solar panel array. In turn, the candidate solar panel array at this adjustment can be selected as a potential recommendation to the utility customer. The computing device may then provide a notification including an indication of the candidate solar panel array corresponding to the cost efficiency metric being less than the predetermined threshold as a recommendation to the corresponding utility customer. The predetermined threshold may be set by the utility customer or a third party handling the solar panel sale and installation.

In one embodiment, the utility customer may be allowed to perform scenario analyses to understand how future behavioral changes or other energy efficiency steps would influence the size and/or potential wattage output of the candidate solar panel array. For example, the utility customer may be prompted to enter suggestive energy usage values that are above or below the obtained energy usage by a defined percentage (e.g., 3-5%).

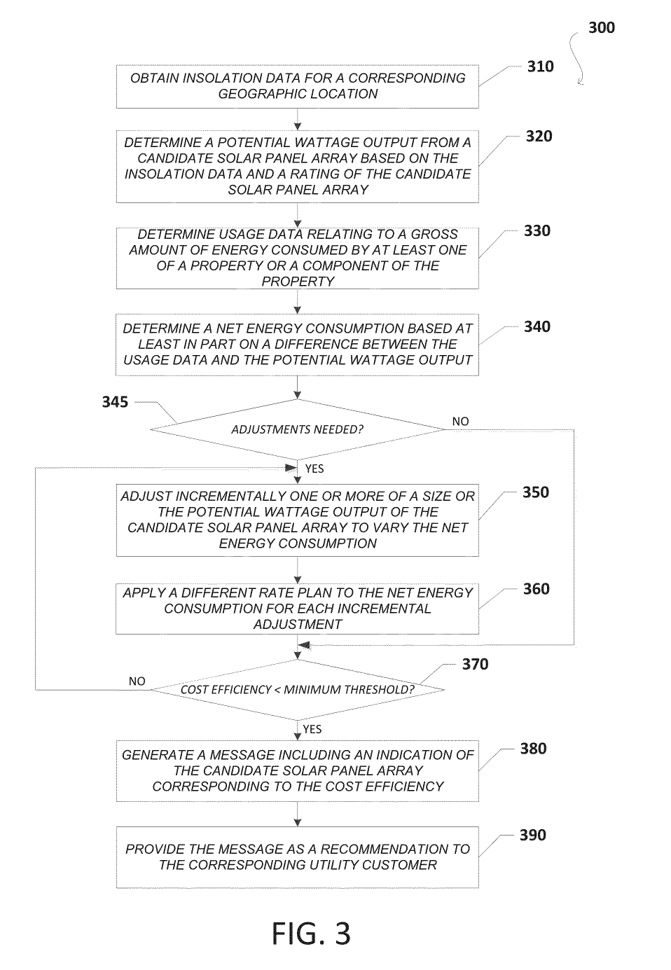

FIG. 3 illustrates a flowchart of an example process 300 for solar panel wattage determination by the utility management system 100 described in FIG. 1, according to certain aspects of the subject technology. The example process 300 is provided merely as an example and additional or fewer steps may be performed in similar or alternative orders, or in parallel, within the scope of the various embodiments described in this specification.

In step 310, a computing device (e.g., the utility management system 100) can obtain insolation data for a corresponding geographic location, in which the insolation data relates to a total amount of solar radiation energy received on a surface area of a candidate solar panel array during a specified time period in the corresponding geographic location. The insolation data may be determined using at least one of historical weather data or forecasted weather data associated with the corresponding geographical region. In this respect, the historical weather data and the forecasted weather data may relate to weather during a time period that corresponds to the specified time period.

In step 320, the computing device can determine a potential wattage output from the candidate solar panel array based on the insolation data and a rating of the candidate solar panel array (or other characteristics of the candidate solar panel array), in which the potential wattage output corresponds to a size of the candidate solar panel array. In this respect, the computing device may calculate a projected energy contribution for the specified time period (e.g., a monthly billing cycle, over a one year period, etc.).

In step 330, the computing device can determine usage data relating to a gross amount of energy consumed by at least one of a property or a component of the property (e.g., an appliance, an HVAC system, etc.), in which the property is associated with a corresponding utility customer in the corresponding geographic location. For example, the computing device may monitor a user's energy usage.

The energy usage data may be based on the user's energy usage history, the usage history of similar users (e.g., neighbors or related utility customers), or the usage history of other utility customers. For example, energy usage report may be 5% less than the user's average usage for the past year. The usage histories may be for the property as a whole and/or disaggregated to show the different components of energy use (e.g., energy usage attributable to an HVAC system). The energy usage data also may be determined using average values of usage histories, linear regressions of usage data, or using some other predictive model.

In an aspect, determining the usage data may include determining rate-of-use information. The rate-of-use may be calculated based on the user's usage history (e.g., based on an average rate for the past 6 months, usage rate during the same time in one or more previous years, average usage rate for a weekday or weekend, usage rates for previous months, etc.).

In certain implementations, information regarding climate control devices (e.g., thermostats) such as how fast a given home will heat up or cool down given that the HVAC system is either on or off may be obtained. In some aspects, rate information of recent days is obtained. The rate information may include time of day, inside temperature, outside temperature, and other factors relating to the climate of the property. A model that captures these parameters as well as the interactions between the parameters can yield rate-of-use estimations.

The rate-of-use model may have a notion of the indoor temperature, outdoor temperature, thermostat set points, HVAC state, solar radiation, and possibly other weather conditions (e.g., humidity, cloud cover, etc.) for every time step that the model simulates. In some aspects, time steps can be at any resolution (seconds, minutes, hours, etc.).

For retrospective analysis, the primary source of data for the model can be one or more of an indoor temperature, an HVAC state, thermostat set point information obtained from network connected thermostats, an outdoor temperature, past solar radiation, or other weather conditions obtained from weather stations. Other data may include HVAC power and square footage.

In some aspects, the usage data is determined using future behavioral usage based on at least one of an energy usage history of the corresponding utility customer, an energy usage history of related utility customers, or energy usage history of utility customers similar to the corresponding utility customer.

For forecasting behavioral usage, the primary source of data for the rate-of-use model may be climate control set point information obtained from schedules of users with network connected thermostats, outdoor temperature, solar radiation (e.g., insolation), and possibly other weather conditions obtained from weather forecasts. The original source data is transformed into a format that can be consumed by the model by matching the source data readings to each time step that the model accounts for.

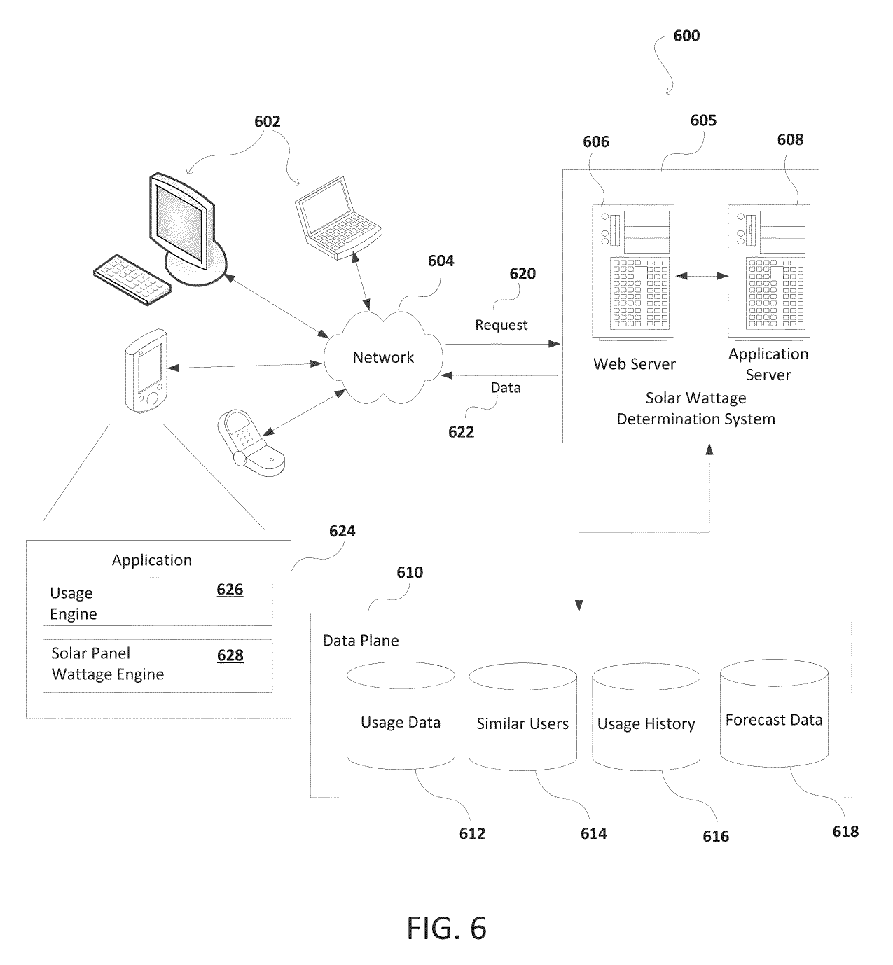

The computing device can send data to a client device (e.g., client devices 602 of FIG. 6) to cause a prompt to be displayed on a user interface of the client device. In an aspect, the prompt includes a request for billing information for one or more billing cycles associated with the corresponding utility customer. In turn, the computing device may receive an input based at least in part on the prompt, in which the input includes the billing information for at least one of the one or more billing cycles such that the usage data can be determined using the billing information received via the input.

In step 340, the computing device can determine net energy consumption based at least in part on a difference between the usage data and the potential wattage output. In an aspect, the computing device can combine the potential energy contribution with the potential energy consumption to yield a net result (e.g., the net energy consumption).

In step 345, the computing device can determine whether adjustments to the candidate solar panel array are requested. In this regard, the computing device may prompt the user on whether the user chooses to adjust one or more parameters relating to the candidate solar panel array. If adjustments are requested by the user, the computing device can proceed to step 350. Otherwise, the process may proceed to step 370.

In step 350, the computing device can adjust incrementally the size or the potential wattage output of the candidate solar panel array to vary the net energy consumption since the net energy consumption is a function of the potential wattage output, which is a function of the solar panel array size. In this regard, the computing device can associate the net energy consumption with a rate plan to determine a cost of energy consumption, and adjust the potential energy contribution to vary the cost of energy consumption.

In step 360, the computing device can apply a different rate plan to the net energy consumption for each incremental adjustment to the size or the potential wattage output of the candidate solar panel array.

In step 370, the computing device can determine that at least one of the adjustments to the size or the potential wattage output of the candidate solar panel array provides a cost efficiency metric that is less than a predetermined threshold, in which the cost efficiency metric relating to a projected financial benefit to the corresponding utility customer. As described above, the cost efficiency metric can relate to a ratio of an installed cost of the solar panel array to the amount of wattage generation capacity of the solar panel array. If the computing device determines that the cost efficiency metric is not less than the predetermined threshold, the process may proceed back to step 350 to apply a different adjustment to the candidate solar panel array. Otherwise, the process may proceed to step 380. In another aspect, the cost efficiency metric and other information related to the relative cost of the candidate solar panel array may be presented to the user in a user interface. The user may also be provided to adjust the solar panel array (e.g., see step 350) and/or apply a different rate plan (e.g., see step 360). If the user elects to adjust the solar panel array or apply a different rate plan, the process may proceed back to step 350 or step 360.

In step 380, the computing device can generate a message including an indication of the candidate solar panel array with the adjustment corresponding to the cost efficiency metric that is less than the predetermined threshold. In an aspect, the message includes information for obtaining a cost estimate from a third party service provider to install the candidate solar panel array at the property. In one embodiment, the message includes information relating to the candidate solar panel array applied with a different size and a respective rate plan for each change in the net energy consumption. In another aspect, the message includes guidance on the one or more adjustments made to the size of the candidate solar panel array and their effect on cost by providing guidance on the corresponding adjustments to the cost of energy consumption.

In step 390, the computing device can further provide the message as a recommendation to the corresponding utility customer. In an aspect, the message is sent to a client device associated with the corresponding utility customer. The message may be sent to the corresponding utility customer via one or more communication channels including, but not limited to, e-mail message, push notification on the client device, a prompt associated with a native application running on the client device, short messaging service (SMS), hardcopy delivery, etc.

In some aspects, the client device is communicatively coupled to a computing device (e.g., the utility management system 100), and may provide an interface with which the user (e.g., utility customer) may select the one or more adjustments to the candidate solar panel array. For example, data may be sent to the client device to cause a prompt to be displayed on the interface and the prompt including one or more options relating to the one or more adjustments to the candidate solar panel array. In turn, the client device may receive an input based at least in part on the prompt. The input may include a selection of at least one of the one or more options. In this respect, the candidate solar panel array may be provided as part of the recommendation using the selected option.

Although the user may select the candidate solar panel array yielding a projected financial benefit to the user, the computing device may automatically select one or more adjustments to the candidate solar panel array, and display the selection(s) to the user on the client device interface. The user may confirm the system selected adjustments, and the solar panel array recommendation may be provided to the client device.

FIG. 4 illustrates an example of an energy usage notification 400 including a solar panel wattage determination, according to certain aspects of the subject technology. The energy usage notification 400 includes a utility identifier 402, a customer account number 404, a notification title 406, a report analysis 408, a report message 410, and a recommendation portion 412. The energy usage notification 400 is provided merely as an example and additional or fewer features may be included in similar or alternative formats within the scope of the various embodiments described in this specification.

The utility identifier 402 may relate to the utility company associated with the generation of the energy usage notification 400. The utility identifier 402 may include a name of the utility company, an address for the utility company, and/or contact information for the utility company.

The account number 404 may relate to the corresponding utility customer subscribed to receive energy usage reports such as the energy usage notification 400. For privacy reasons, the customer account number 404 may be limited to a subset of numbers that, at least in part, identify the utility account. In an aspect, the customer account number 404 is displayed in its entirety.

The notification title 406 provides an identification of the type of notification contained in the energy usage notification 400. For example, the notification title 406 may relate to a utility bill where the notification 400 provides the utility customer an indication on an actual cost and/or projected cost for usage of a commodity in a current billing period. The energy usage notification 400 may be sent to the utility customer before the end of the current billing period to allow the utility customer time to make any adjustments to current energy consumption at the corresponding property.

The report analysis 408 may include information relating to how the current projected bill compares to prior utility bills, and may include a metric to give the utility customer some context to the current projected bill. The report analysis 408 may include additional metrics such as a chart to provide the utility customer a visual analysis of the current projected bill. The report analysis 408 may include information relating to actual energy usage for the current billing period, and include information relating to a projected energy usage for a next billing period.

The report message 410 may include an indication to the utility customer that alterations can be pursued to reduce future energy costs. For example, the indication may include a recommendation to the utility customer that one or more alternative energy strategies (e.g., solar power generation) are available to the utility customer based on one or more aspects about the utility customer's energy usage pattern. The report message 410 may include an indication to the utility customer that the projected bill can still be altered if certain adjustments can be made prior to the end of the current billing period. The report message 410 also may include other report messages relating to the current projected bill such as usage information relating to specific components of the property and/or rate information over the duration of the current billing period.

The recommendation portion 412 may include one or more recommendations suggesting to the utility customer to conduct an energy audit to help the utility customer discover energy savings via one or more alternative energy strategies. In one embodiment, the recommendation portion 412 includes information relating to a recommended solar panel system. For example, the recommendation portion 412 includes information regarding solar insolation data for the geographic region corresponding to the utility customer (e.g., 1000 kWh per kWp*y), information relating to projected solar panel wattage to meet the utility customer's projected usage (e.g., 530 kWh), and information relating to the size of the candidate solar panel array to meet the utility client's projected energy usage (e.g., 425 sq-ft). The recommendation portion 412 also may include one or more of a summary of benefits for choosing solar power generation, a link to online resources relating to solar power generation (e.g., find a local contractor), information explaining the role of the utility company during a solar activation process, etc.

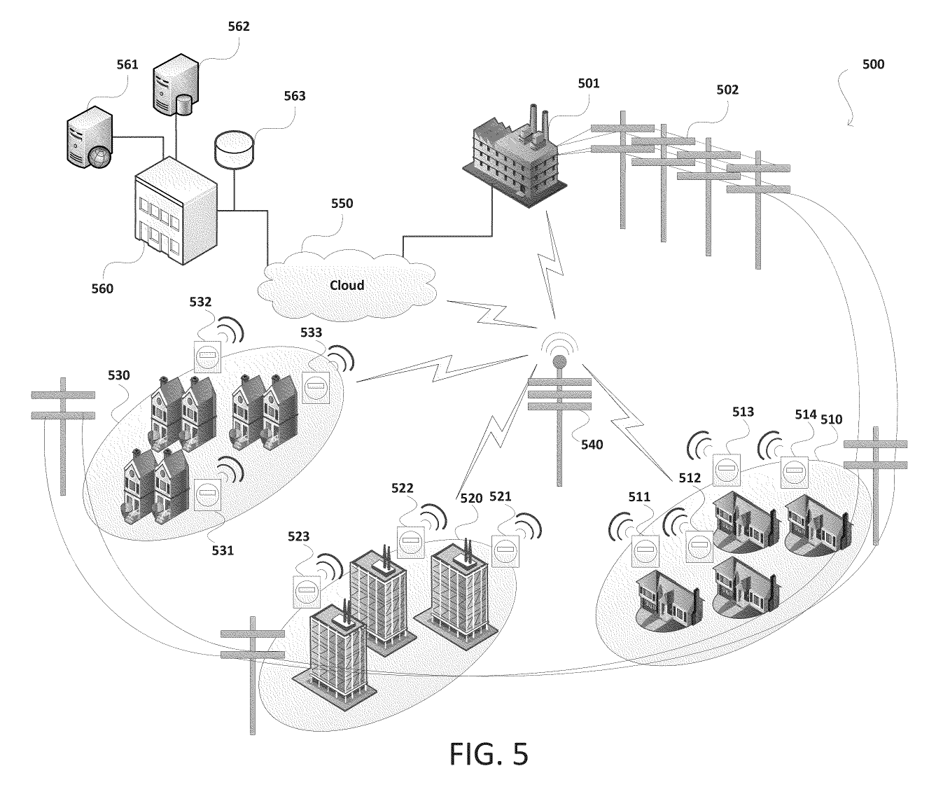

FIG. 5 illustrates an example of an environment 500 for implementing aspects in accordance with various embodiments. The environment 500 includes a utility company 501, power distribution system 502, utility customer regions 510, 520 and 530, energy usage collector 540, a network 550 and a solar panel wattage determination system 560. The utility customer region 510 includes residential structures with corresponding smart meters 511-514. The utility customer region 520 includes commercial structures with corresponding smart meters 521-523. The utility customer region 530 includes multi-family structures with corresponding smart meters 531-533. The solar panel wattage determination system 560 includes a web server 561, an application server 562 and a database 563.

The utility company 501 provides a commodity (e.g., electricity, gas, water) to the utility customer regions 510, 520 and 530. The utility company 501 may track the energy usage from each region via a monitoring device (e.g., a smart meter) associated with each structure of the corresponding region. The utility company 501 may receive usage data that includes the amount of energy consumption (e.g., kWh) for the corresponding utility account. In an aspect, the utility company 501 receives the usage data from the energy usage collector 540 via a wireless communication system. In some aspects, the energy usage collector 540 may obtain the usage data by pulling the usage data from each of the smart meter devices. The smart meter devices may broadcast usage data on a periodic or scheduled basis. The utility company 501 also may receive the usage data from each monitoring device through a wired communication system.

The solar panel wattage determination system 560 is in communication with the utility company 501 via the network 550. The solar panel wattage determination system 560 may obtain the usage data from the utility company 501 via the network 550. In an aspect, the solar panel wattage determination system 560 receives the usage data via the network 550. The solar panel wattage determination system 560 may receive the usage data directly from the smart meter devices.

Each of the utility customer regions 510, 520 and 530 may correspond to a separate geographical location with a respective rate schedule. In some aspects, one or more of the structures in the utility customer regions 510, 520 and 530 include an installed solar panel array to generate power for use locally and/or to be sent back to the grid (e.g., power distribution system 502) using an inverter device installed at the structure. An energy usage notification for a corresponding utility customer in one region may be generated using usage data of similar users in the same region to provide the corresponding utility customer with a comparative analysis of its energy consumption (e.g., current energy usage compared to similar customers in the same zip code or within a certain radius).

The solar panel wattage determination system 560 also may be in communication with a third party weather service, such as the National Weather Service (not shown). For example, the solar panel wattage determination system 560 may receive corresponding outdoor temperatures from the third party weather service via the network 550 (e.g., e-mails, downloaded FTP files, and XML feeds). In this respect, the solar panel wattage determination system 560 may use data from the third party weather service in combination with solar insolation data (e.g., insolation data 107 of FIG. 1) to determine a projected energy contribution from a candidate solar panel array. For example, forecasted weather conditions (e.g., the temperature, the humidity, the barometric pressure, precipitation, etc.) may indicate that the utility customer's HVAC system is likely to be in greater use. The solar panel wattage determination system 560 may use the data from the third party weather service, at least in part, to determine the solar insolation data.

The solar panel wattage determination system 560 may recommend the candidate solar panel array that provides a projected financial benefit to the utility customer (e.g., highest return-of-investment (ROI) within a projected period of time). In turn, the solar panel wattage determination system 560 may notify the utility customer of the solar panel recommendation through the energy usage notification.

The solar panel wattage determination system 560 communicates the energy usage notification to utility customers associated with the utility customer regions 510, 520 and 530. In some aspects, the solar panel wattage determination system 560 communicates the energy usage notification via the network 550. For example, the solar panel wattage determination system 560 may send the energy usage notification in an e-mail or the utility customer may log into the solar panel wattage determination system 560 (e.g., the web server 561 and/or application server 562) through an associated website to view the disaggregated usage data included in the energy usage notification. In this respect, the energy usage notification may include a recommendation for solar power generation to supply power to a particular component at the property (e.g., solar-based water heater) using the disaggregated usage data. The solar panel wattage determination system 560 may send the energy usage information to a printing system so that the energy usage notification can be provided to the utility customer via regular mail (e.g., as part of a utility bill). In other embodiments, the energy usage information is communicated back to the utility company 501 such that the utility company 501 can provide the energy usage notification to the utility customer.

FIG. 6 illustrates an example of a system 600 for solar panel wattage determination, according to certain aspects of the subject technology. Although a web-based environment is described for purposes of explanation, different environments may be used, as appropriate, to implement various embodiments.

The example system 600 includes a solar panel wattage determination system 605 and a data plane 610. The solar panel wattage determination system 605 includes at least one web server 606 and at least one application server 608, as described below. The solar panel wattage determination system 605 is an example of a computing system for determining an optimized solar panel array implemented as computer programs on one or more computers in one or more locations, in which the systems, components, and techniques described below, can be implemented.

A user can interact with the solar panel wattage determination system 605 through a client device 602. For example, the client device 602 can be a computer coupled to the solar panel wattage determination system 605 through a data communication network 604, e.g., the Internet. In some instances, the solar panel wattage determination system 605 can be implemented on the client device 602, for example, through a software application executing on the client device 602. The client device 602 generally includes a memory, e.g., a random access memory (RAM), for storing instructions and data, and a processor for executing stored instructions. The client device 602 can be any appropriate device operable to send and receive requests, messages, or other types of information over the data communication network 604. The client device 602 can also include a display screen though which the user interacting with the client device 602 can view information, e.g., energy usage notification 400 of FIG. 4. Some examples of client devices include personal computers, smart thermostats, cellular phones, handheld messaging devices, laptop computers, set-top boxes, personal data assistants, electronic book readers, tablet devices, smartphones and the like.

The data communication network 604 can include any appropriate network, including an intranet, the Internet, a cellular network, a local area network, a wide area network, or any other such network, or combination thereof. Components used for such a system can depend at least in part upon the type of network, the environment selected, or both. Protocols and components for communicating over such a network are well known and will not be discussed herein in detail. The client device 602 can communicate over the data communication network 604 using wired or wireless connections, and combinations thereof.

A user can use the client device 602 to submit a request 620 to log into the solar panel wattage determination system 605. The request 620 can request a calculation to determine an optimized solar panel array for a corresponding utility account. The calculation may include information relating to how much energy has been consumed to date and/or a projected energy usage for a current and/or future billing period. The calculation also can include information relating to one or more recommendations for adjusting a size of a candidate solar panel array to satisfy a budgeted usage amount. When the user submits the request 620, the request 620 may be transmitted through the data communication network 604 to the application server 608 within the solar panel wattage determination system 605. The application server 608 responds to the request 620 by using, for example, usage data 612, to identify data 622 describing a solar panel wattage determination with personalized information in response to the request 620. The application server 608 sends the data 622 through the data communication network 604 to the client device 602 for presentation to the user. For example, the data 622 may include information relating to dimensions of the solar panel array, location coordinates of the property, calculated energy usage based on billing information and/or AMI data corresponding to the property. In an aspect, the data 622 includes solar insolation data for processing the solar panel wattage determination at the client device 602.

After receiving the data 622 from the application server 608, and through the data communication network 604, a software application, e.g., web browser or application 624, running on the client device 602 renders an interactive energy usage notification using the data 622. For example, a usage engine 626 in the application 624 can describe the usage to date including a projected use for the current billing period, for display on a display screen of the client device 602.

In some aspects, the application 624 includes a solar panel wattage engine 628 that is configured to render an interface to the client device 602, and perform one or more actions related to instructions for determining the solar panel wattage at the client device 602. In some embodiments, the solar panel wattage engine 628 is configured to obtain data relating to current and/or future insolation for the corresponding geographic region (e.g., residential neighborhood of utility customer). The solar panel wattage engine 628 may obtain real-time statistics and/or sensor readings of current energy usage to determine rate-of-use information. In an aspect, the solar panel wattage engine 628 may obtain rating information and/or characteristics (e.g., dimensions) of a candidate solar panel array.

In some embodiments, the web server 606, the application server 608, and similar components, can be considered to be part of the data plane 610. The handling of all requests and responses, as well as the delivery of content between the client device 602 and the application server 608, can be handled by the web server 606. The web server 606 and the application server 608 are merely example components. However, more or fewer components can be used as structured code can be executed on any appropriate device or host machine as discussed elsewhere herein.

The data plane 610 includes one or more resources, servers, hosts, instances, routers, switches, data stores, other similar components, or a combination thereof. The resources of the data plane 610 are not limited to storing and providing access to data. Indeed, there may be several servers, layers, or other elements, processes, or components, which may be chained or otherwise configured, and which can interact to perform tasks including, for example, obtaining data from an appropriate data store. In some embodiments, the term “data store” refers to any device or combination of devices capable of storing, accessing, and retrieving data, which may include any combination and number of data servers, databases, data storage devices, and data storage media, in any standard, distributed, or clustered environment.

The data stores of the data plane 610 can include several separate data tables, databases, or other data storage mechanisms and media for storing data relating to a particular aspect. For example, the data plane 610 illustrated includes mechanisms for storing usage data 612, user information 616 and forecast data 618, which can be used to generate the energy usage notification along with one or more recommendations relating to the candidate solar panel array. The data plane 610 is also shown to include a mechanism for storing similar user data 614, which can be used for purposes such as reporting a comparative analysis of the usage data for the corresponding utility customer. The data plane 610 is operable, through logic associated therewith, to receive instructions from the application server 608 and to obtain, update, or otherwise process data, instructions, or other such information in response thereto, as described above.

Each server typically includes an operating system that provides executable program instructions for the general administration and operation of that server, and typically will include a computer-readable medium storing instructions that, when executed by a processor of the server, enable the server to perform its intended functions. Suitable implementations for the operating system and general functionality of the servers are known or commercially available, and are readily implemented by persons having ordinary skill in the art, particularly in light of the disclosure herein.

The environment in one embodiment is a distributed computing environment including several computer systems and components that are interconnected through one or more communication links, using one or more computer networks or direct connections. However, the system described above can be configured to operate equally well using fewer or a greater number of components than are illustrated in FIG. 6. Thus, the system 600 in FIG. 6 is provided merely as one example, and does not limit the scope of the disclosure.

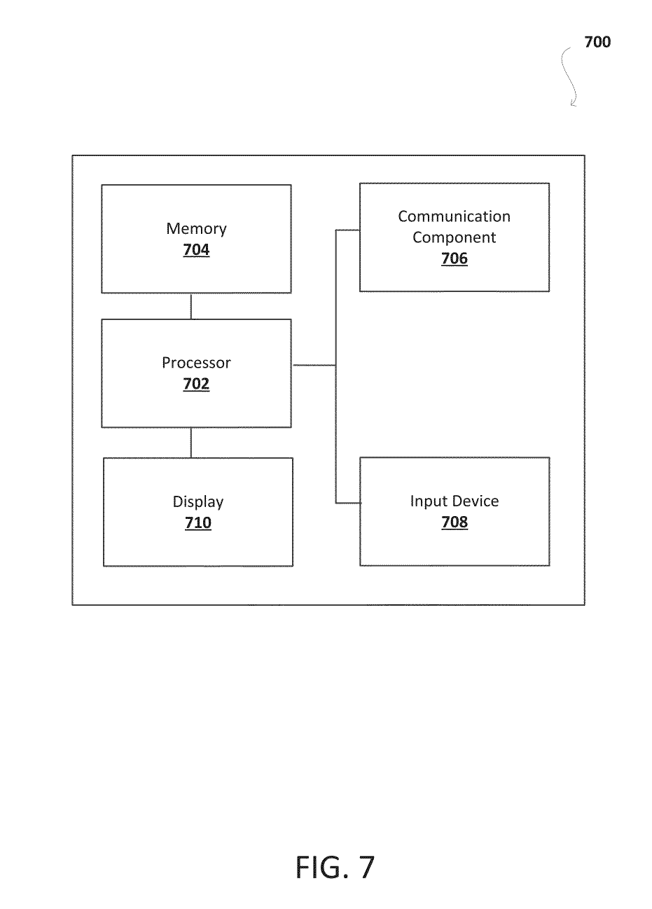

FIG. 7 illustrates an example configuration of components of a computing device 700, e.g., the climate control devices 103a-103n of FIG. 1, according to certain aspects of the subject technology. In this example, the computing device 700 includes a processor 702 for executing instructions that can be stored in a memory device or element 704. The instructions may cause the computing device 700 to execute a computer-implemented method for processing energy usage notifications containing one or more solar panel recommendations from the solar panel wattage determination system 605 (FIG. 6) and/or receive instructions to automatically forward the solar panel recommendations to a third party solar panel provider and/or installer.

As would be apparent to one of ordinary skill in the art, the computing device 700 can include many types of memory, data storage, or non-transitory computer-readable storage media, such as a first data storage for program instructions for execution by the processor 702, a separate storage for usage history or user information, a removable memory for sharing information with other devices, etc. In some embodiments, the computing device 700 can include one or more communication components 706, such as a Wi-Fi, Bluetooth®, radio frequency, near-field communication, wired, or wireless communication system. The computing device 700 in many embodiments can communicate with a network, such as the Internet, and may be able to communicate with other such devices (e.g., the solar panel wattage determination system 100, other climate control devices).

As discussed, the computing device 700 in many embodiments will include at least one input element 708 able to receive conventional input from a user. This conventional input can include, for example, a push button, touch pad, touch screen, wheel, joystick, keyboard, mouse, keypad, or any other such device or element whereby a user can input a command to the device. In some embodiments, however, such a device might not include any buttons at all, and might be controlled only through a combination of visual and audio commands, such that a user can control the device without having to be in contact with the device. The computing device 700 includes some type of display element 710, such as a touch screen or liquid crystal display (LCD).

The various embodiments can be implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Various aspects also can be implemented as part of at least one service or Web service, such as may be part of a service-oriented architecture. Services such as Web services can communicate using any appropriate type of messaging, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most embodiments utilize at least one network that would be familiar to those skilled in the art for supporting communications using any of a variety of commercially-available protocols, such as TCP/IP, OSI, FTP, UPnP, NFS, and CIFS. The network can be, for example, a local area network, a wide-area network, a virtual private network, the Internet, an intranet, an extranet, a public switched telephone network, an infrared network, a wireless network, and any combination thereof

In embodiments utilizing a Web server, the Web server can run any of a variety of server or mid-tier applications, including HTTP servers, FTP servers, CGI servers, data servers, Java servers, and business map servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

The description of the subject technology is provided to enable any person skilled in the art to practice the various embodiments described herein. While the subject technology has been particularly described with reference to the various figures and embodiments, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these embodiments will be readily apparent to those skilled in the art, and generic principles defined herein may be applied to other embodiments. Thus, many changes and modifications may be made to the subject technology, by one having ordinary skill in the art, without departing from the scope of the subject technology.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various embodiments described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A computing device for solar panel wattage determination, the computing device comprising:
at least one processor; and
memory storing instructions that, when executed by the at least one processor, cause the computing device to:
obtain insolation data for a corresponding geographic location, the insolation data relating to a total amount of solar radiation energy received on a surface area of a candidate solar panel array during a specified time period in the corresponding geographic location;
determine a potential wattage output from the candidate solar panel array based on the insolation data and a rating of the candidate solar panel array, the potential wattage output corresponding to a size of the candidate solar panel array;
determine usage data relating to a gross amount of energy consumed by at least one of a property or a component of the property, the property associated with a corresponding utility customer in the corresponding geographic location;
determine a net energy consumption based at least in part on a difference between the usage data and the potential wattage output;
determine that the potential wattage output of the candidate solar panel array provides a cost efficiency metric that is less than a predetermined threshold, the cost efficiency metric relating to a projected financial benefit to the corresponding utility customer;
generate a message including an indication of the candidate solar panel array with the adjustment corresponding to the cost efficiency metric that is less than the predetermined threshold; and
provide the message as a recommendation to the corresponding utility customer.

2. The computing device of claim 1, wherein the instructions further cause the computing device to determine a cost associated with a third party installation of the candidate solar panel array at the property, and wherein the size or the potential wattage output of the candidate solar panel array is adjusted based on the cost associated with the third party installation of the solar panel array.

3. The computing device of claim 1, wherein the usage data is based at least in part on an energy usage history of the corresponding utility customer, the energy usage history relating to one or more of an average usage rate for a specified number of months, a usage rate during the specified time period for one or more previous years, an average usage rate for a particular weekday or weekend, and usage rates for one or more months preceding the specified time period.

4. The computing device of claim 1, wherein the usage data relating to energy consumed by the component of the property is obtained from at least one of a usage monitoring device associated with the component or a disaggregation of the usage data corresponding to the property.

5. The computing device of claim 1, wherein the instructions further cause the computing device to:
adjust incrementally one or more of the size or the potential wattage output of the candidate solar panel array to vary the net energy consumption; and
apply a different rate plan of a plurality of rate plans to the net energy consumption for each incremental adjustment to the size or change in the potential wattage output of the candidate solar panel array;

6. A computer-implemented method, comprising:
determining a potential energy contribution from a candidate solar panel array based at least in part on insolation data for a corresponding geographic region;
determining a potential energy consumption relating to energy consumed by a property of a corresponding utility customer, the property located within the corresponding geographic region;
combining the potential energy contribution with the potential energy consumption to determine a net energy consumption;
determining a cost efficiency metric relating to a projected financial benefit to the corresponding utility customer based at least in part on one or more adjustments to the net energy consumption; and
providing a notification including an indication of the solar panel array with the adjustment corresponding to the cost efficiency metric as a recommendation to the corresponding utility customer.

7. The computer-implemented method of claim 6, further comprising:
adjusting incrementally one or more of a size or a potential energy contribution of the candidate solar panel array to vary the net energy consumption; and
applying a different rate plan of a plurality of rate plans to the net energy consumption for each incremental adjustment to the size or the potential energy contribution of the candidate solar panel array.

8. The computer-implemented method of claim 7, further comprising determining that one of the adjustments to the candidate solar panel array provides the cost efficiency metric to be less than a predetermined threshold.

9. The computer-implemented method of claim 6, further comprising:
sending data to a client device to cause a prompt to be displayed on a user interface of the client device, the prompt including one or more options relating to the one or more adjustments to the candidate solar panel array; and
receiving an input based at least in part on the prompt, the input including a selection of at least one of the one or more options, the candidate solar panel array being provided as part of the recommendation using the selected one or more options.

10. The computer-implemented method of claim 9, wherein the prompt includes a request for billing information for one or more billing cycles associated with the corresponding utility customer; and
receiving an input based at least in part on the prompt, the input including the billing information for at least one of the one or more billing cycles, the potential energy consumption being determined using the billing information received via the input.

11. The computer-implemented method of claim 6, further comprising:
selecting at least one of the one or more adjustments to the candidate solar panel array;
providing the one or more adjustments as options to cause a prompt to be displayed on a user interface of a client device; and
receiving an input based at least in part on the prompt, the input including a confirmation for the one or more adjustments.

12. The computer-implemented method of claim 6, wherein determining the potential energy consumption comprises determining future behavioral usage using at least one of an energy usage history of the corresponding utility customer, an energy usage history of related utility customers, or energy usage history of utility customers similar to the corresponding utility customer.

13. The computer-implemented method of claim 6, wherein the insolation data is determined using at least one of historical weather data or forecasted weather data associated with the corresponding geographical region, the historical weather data and the forecasted weather data relating to weather during a time period that corresponds to a current billing cycle.

14. The computer-implemented method of claim 6, wherein the one or more recommendations include information for obtaining a cost estimate from a third party service provider to install the candidate solar panel array at the property.

15. The computer-implemented method of claim 6, wherein the notification includes information relating to the candidate solar panel array applied with a different size and a respective rate plan for each change in the net energy consumption.

16. The computer-implemented method of claim 6, further comprising:
associating the net energy consumption with a rate plan to determine a cost of energy consumption; and
adjusting the potential energy contribution to vary the cost of energy consumption.

17. The computer-implemented method of claim 16, wherein the notification includes guidance on one or more adjustments to a size of the candidate solar panel array and corresponding adjustments to the cost of energy consumption.

18. A non-transitory computer readable storage medium storing instructions for solar panel wattage determination on a computing device, the instructions when executed by a processor causing the processor to:
determine a potential wattage output of a candidate solar panel array using insolation data for a corresponding geographic region;
determine a potential energy consumption for a property of a corresponding utility customer based at least in part on usage data of the property, the property located within the corresponding geographic region;
adjust a size of the candidate solar panel array to vary the potential wattage output;
apply a different rate plan of a plurality of rate plans to the potential energy consumption for each change in the potential wattage output;
determine that one of the changes in the potential wattage output of the candidate solar panel array provides a cost efficiency metric that is less than a predetermined threshold; and
provide a notification including an indication of the candidate solar panel array corresponding to the cost efficiency metric that is less than the predetermined threshold as a recommendation to the corresponding utility customer.

19. The non-transitory computer readable storage medium of claim 18, wherein the instructions further cause the computing device to determine a cost associated with a third party installation of the candidate solar panel array at the property, and wherein the size or the potential wattage output of the candidate solar panel array is adjusted based on the cost associated with the third party installation of the solar panel array.

20. The non-transitory computer readable storage medium of claim 18, wherein the predetermined threshold relates to a ratio of an installed cost of the candidate solar panel array to a generation capacity of the candidate solar panel array.
